(19) United States
(12) Patent Application Publication
(10) Pub. No.: US 2015/0278911 A1
(43) Pub. Date: Oct. 1, 2015

(54) System and Method for Apparel Size Suggestion Based on Sales Transaction Data Analysis

(71) Applicant: Juergen Rink, Waldorf (DE)

(72) Inventor: Juergen Rink, Brobrosseln (DE)

(73) Assignee: SAP AG, Walldorf (DE)

(21) Appl. No.: 14/231,587

(22) Filed: Mar. 31, 2014

(51) Int. Cl. G06Q 30/06; G06Q 20/20

(52) U.S. Cl. CPC G06Q 30/0631; G06Q 20/20

(57) ABSTRACT

A system and method for apparel size suggestion based on sales transaction data analysis are presented. Historical sales data for a consumer is stored in a repository of a data management system, the historical sales data representing a purchase history and comprising size data for ordered items and size data for returned items. A body profile for the consumer is generated based on the size data for ordered items and the size data for returned items, the body profile including size data for one or more selected items, the one or more selected items being selected by the data management system based on the purchase history of the historical sales data for the consumer. An order from the consumer is received for an ordered item, and if the ordered item matches one of the one or more selected items, a recommended size is generated for the ordered item based on the body profile and historical sales data.

### TECHNICAL FIELD

The subject matter described herein relates to point-of-sale (POS) data management, and more particularly to a system and method for generating a recommended size for an ordered item based on a body profile and historical sales data related to a consumer.

### BACKGROUND

Apparel, clothing and fashion articles such as footwear and accessories, generally referred to herein as “apparel,” are typically labeled with a size that is supposed to correspond to one or more body dimensions, such as width, length, height, etc. Multiple different standards and systems, in effect or proposed by regional, national or global standard organizations, exist worldwide for designating apparel sizes. In addition, many apparel manufacturers or dealers have their own systems for defining apparel sizes, typically based on specific body mass.

This situation is baffling to consumers. When purchasing apparel, they often do not know which apparel size would fit their specific body dimensions. Even if a consumer finds an ideal size for a specific article of apparel, they will usually experience that they have to select a different apparel size when buying a similar article from different vendors, labels or dealers.

Therefore, when buying apparel at online shops in which the apparel is selected electronically and remotely and then shipped to a destination, consumers tend to order the same item in multiple, different sizes. They try all or more of the items at home, keep the best fitting one, and then return the others back to the seller. This leads to massively increased shipping, logistics and other service costs for online apparel merchants.

### SUMMARY

In one aspect, a system, method and computer program product are provided, and which include the operations of storing historical sales data for a consumer in a repository of a data management system, the historical sales data representing a purchase history and comprising size data for ordered items and size data for returned items. The operations further include generating a body profile for the consumer based on the size data for ordered items and the size data for returned items, the body profile including size data for one or more selected items, the one or more selected items being selected by the data management system based on the purchase history of the historical sales data for the consumer. The operations further include receiving, from a point-of-sale computing system by the data management system, an order from the consumer for an ordered item; and if the ordered item matches one of the one or more selected items, generating a recommended size for the ordered item based on the body profile and historical sales data.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a block diagram of a system for generating a recommended size for an item being ordered by a consumer;

FIG. 2 is a flowchart of a method of generating a recommended size for an item being ordered by a consumer;

When practical, similar reference numbers denote similar structures, features, or elements.

### DETAILED DESCRIPTION

To address the aforementioned and potentially other issues with currently available solutions, this document discloses methods, systems, articles of manufacture, and the like, consistent with one or more implementations of the current subject matter, which can provide a recommended size for an item ordered online based on a body profile and historical sales data related to a consumer. These methods, systems and articles of manufacture eliminate unnecessary shipping, logistics and other service costs for merchants and consumers alike, while conserving significant time and other resources for online transactions for apparel.

In accordance with implementations consistent with subject matter disclosed herein, a retailer's commerce system can generate and propose a best fitting apparel size to a consumer for each item of apparel ordered by the consumer, based on analytical insights of consumer's ordering and buying behavior as well aggregate consumer behavior.

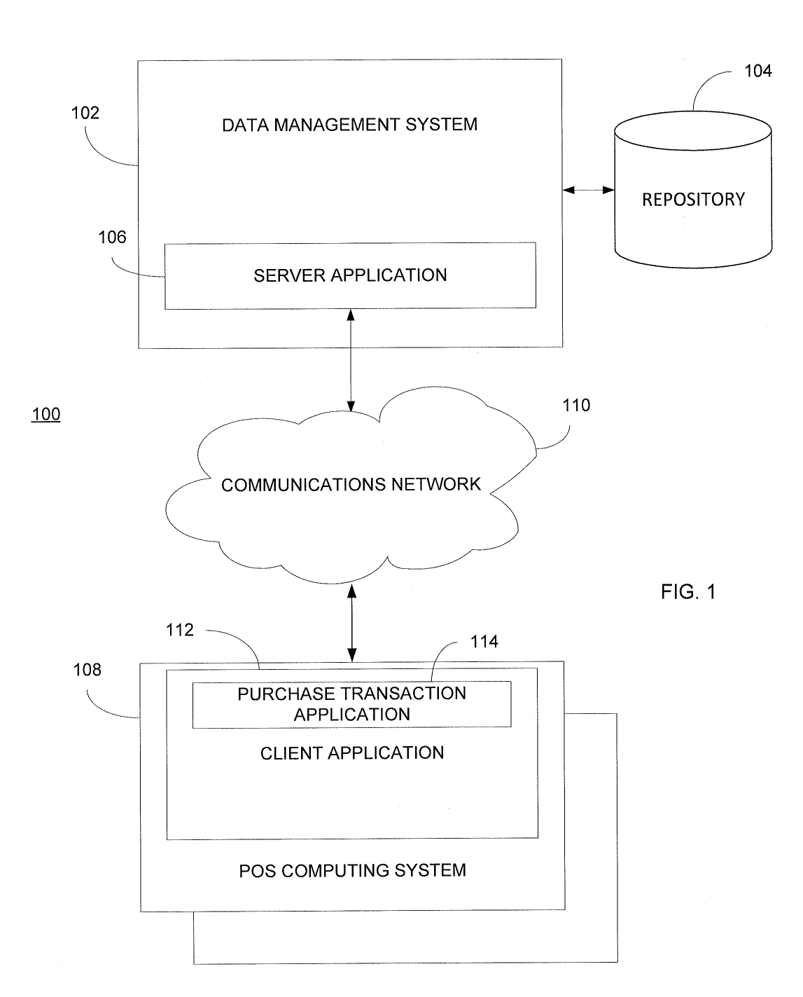

FIG. 1 is a block diagram of a system 100 for generating a recommended size for an item being ordered by a consumer in an online commercial transaction. The system includes a data management system 102 and a repository 104 associated with the data management system 102. The data management system 102 includes one or more computer processors executing a server application 106 that provides apparel offerings to one or more consumers operating a point-of-sale (POS) computing system 108 via a communications network 110. The POS computing system 108 having one or more computer processors that execute a client application 112 that displays the apparel offerings from the server application 106, and includes a purchase transaction application 114 to receive an order from the consumer, accept a payment for the order, and initiate the deliver of the order by the data management system 102.

In some implementations, a consumer's sales history is stored in the data management system 102, such as, for example, any of SAP POS Data Management, SAP Consumer Activity Repository, and SAP Business Information Warehouse. The data management system is associated with a repository in which the sales history is stored. The data management system can include one or more databases and/or in-memory storage systems, and can include a repository that stores apparel data representing apparel that is available for ordering online. The sales history includes sales data representing sales orders by the consumer, and return data representing the ordered apparel that has been returned to the merchant by the consumer. The data management system can determine a size for each item that has been ordered and received by the consumer but never returned.

In some implementations, the data management system generates a body size profile for each consumer and stores the body size profile in the repository. For an item ordered by consumers with the same body size profile, the data management system can generate similar recommended sizes. Accordingly, the data management system generates a best fitting size for a specific item and a specific consumer. The best fitting size generated by the data management system can be accompanied by brand or source designator, which will inform consumers of the source of the recommended size, which the consumers will trust. Further, the more accurate the recommended size, the fewer returns will be made by consumers, thereby reducing shipping, logistics and other service costs, while making online transactions and delivery of ordered apparel items more efficient and effective.

In accordance with some implementations, a data management system computes and transmits a recommended best size, which can be done simultaneously or in near real-time during an online shopping transaction by a consumer. In some implementations, the data management system analyzes the stored sales history of the individual consumer, as well as sales histories of all other consumers with the same or similar body profile. Body profiles can be determined from sales history by determining the “never returned sizes” of each consumer and comparing that information among consumers. The data management system identifies a size for a selected item (i.e. an item being ordered) that has the estimated best fit for the ordering consumer by determining the size with the minimal return rate for all consumers with same or similar body profile as the purchasing consumer. In accordance with some implementations, each consumer in an online transaction is identified by login and/or identification data supplied by the consumer, which identification data is used by the data management system to look up the consumer in the repository and retrieve the consumer's body profile. The system and method executed thereby reduces service costs for retailers, and increases convenience for consumers.

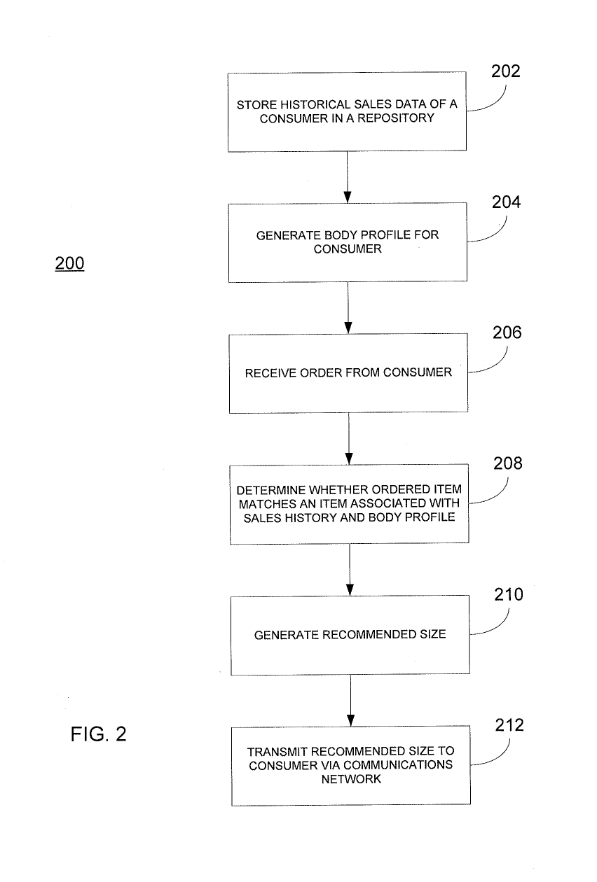

FIG. 2 is a flowchart of a method 200 of generating a recommended size for an item being ordered by a consumer, as executed between a data management system and a client computer operated by a consumer. At 202 historical sales data for a consumer is stored in a repository of a data management system. The historical sales data represents a purchase history and includes size data for ordered items and size data for returned items associated with the consumer. At 204, a body profile is generated for the consumer based on the size data for ordered items and the size data for returned items. The body profile includes size data for one or more selected items. The one or more selected items are selected by the data management system based on the purchase history as represented by the historical sales data for the consumer.

At 206, an order from the consumer for an ordered item is received from a point-of-sale (POS) computing system by the data management system. The POS computing system can be a client computer such as a desktop computer, a laptop computer, a smart phone, or any other mobile computer. The POS computing system is connected with the data management system via a communication network. At 208 it is determined whether the ordered item matches one of the one or more selected items. If the ordered item matches one of the one or more selected items, at 210 a recommended size for the ordered item is generated based at least on the body profile and historical sales data. At 212, the data management system transmits the recommended size associated with the offer to the point-of-sale computing system via one or more communications networks.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
storing historical sales data for a consumer in a repository of a data management system, the historical sales data representing a purchase history and comprising size data for ordered items and size data for returned items;
generating a body profile for the consumer based on the size data for ordered items and the size data for returned items, the body profile including size data for one or more selected items, the one or more selected items being selected by the data management system based on the purchase history of the historical sales data for the consumer;
receiving, from a point-of-sale computing system by the data management system, an order from the consumer for an ordered item; and
if the ordered item matches one of the one or more selected items, generating a recommended size for the ordered item based on the body profile and historical sales data.

2. The method in accordance with claim 1, further comprising transmitting, by the data management system to the point-of-sale computing system, the recommended size associated with the offer.

3. The method in accordance with claim 1, wherein the historical sales data includes size data for items that have not been returned by the customer.

4. The method in accordance with claim 1, wherein the body profile includes personal information of the consumer, the personal information including at least one of height, weight, gender, or body measurements.

5. The method in accordance with claim 4, wherein the body profile includes personal information of a set of consumers, each consumer in the set of consumers having an associated body profile within a range of body profiles.

6. The method in accordance with claim 5, further comprising comparing the body profile for the consumer with the body profile of each consumer in the set of consumers to generate the recommended size for the ordered item.

7. A non-transitory computer program product storing instructions that, when executed by at least one programmable processor, cause the at least one programmable processor to perform operations comprising:
store historical sales data for a consumer in a repository, the historical sales data representing a purchase history and comprising size data for ordered items and size data for returned items;
generate a body profile for the consumer based on the size data for ordered items and the size data for returned items, the body profile including size data for one or more selected items, the one or more selected items being selected by the data management system based on the purchase history of the historical sales data for the consumer;
receive, from a point-of-sale computing system, an order from the consumer for an ordered item; and
if the ordered item matches one of the one or more selected items, generate a recommended size for the ordered item based on the body profile and historical sales data.

8. The computer program product in accordance with claim 7, wherein the operations further comprise an operation to transmit, by the data management system to the point-of-sale computing system, the recommended size associated with the offer.

9. The computer program product in accordance with claim 7, wherein the historical sales data includes size data for items that have not been returned by the customer.

10. The computer program product in accordance with claim 7, wherein the body profile includes personal information of the consumer, the personal information including at least one of height, weight, gender, or body measurements.

11. The computer program product in accordance with claim 10, wherein the body profile includes personal information of a set of consumers, each consumer in the set of consumers having an associated body profile within a range of body profiles.

12. The computer program product in accordance with claim 11, further comprising comparing the body profile for the consumer with the body profile of each consumer in the set of consumers to generate the recommended size for the ordered item.

13. A system comprising:
at least one programmable processor; and
a machine-readable medium storing instructions that, when executed by the at least one processor, cause the at least one programmable processor to perform operations comprising:
store historical sales data for a consumer in a repository, the historical sales data representing a purchase history and comprising size data for ordered items and size data for returned items;
generate a body profile for the consumer based on the size data for ordered items and the size data for returned items, the body profile including size data for one or more selected items, the one or more selected items being selected by the data management system based on the purchase history of the historical sales data for the consumer;
receive, from a point-of-sale computing system, an order from the consumer for an ordered item; and
if the ordered item matches one of the one or more selected items, generate a recommended size for the ordered item based on the body profile and historical sales data.

14. The system in accordance with claim 13, wherein the operations further comprise an operation to transmit, by the data management system to the point-of-sale computing system, the recommended size associated with the offer.

15. The system in accordance with claim 13, wherein the historical sales data includes size data for items that have not been returned by the customer.

16. The system in accordance with claim 13, wherein the body profile includes personal information of the consumer, the personal information including at least one of height, weight, gender, or body measurements.

17. The system in accordance with claim 16, wherein the body profile includes personal information of a set of consumers, each consumer in the set of consumers having an associated body profile within a range of body profiles.

18. The system in accordance with claim 17, further comprising comparing the body profile for the consumer with the body profile of each consumer in the set of consumers to generate the recommended size for the ordered item.
